(19) United States
(12) Patent Application Publication
(10) Pub. No.: US 2013/0036635 A1
(43) Pub. Date: Feb. 14, 2013

(54) SMART PHONE GREETING CARD

(71) Applicant: American Greetings Corporation, Cleveland, OH (US)

(72) Inventors: David MAYER, Bay Village, OH (US); Lynne Shlonsky, Shaker Heights, OH (US); Dave SAPP, Avon Lake, OH (US); John TALBOTT, Bay Village, OH (US); Seth LARSON, Lakewood, OH (US); Gary NELSON, Avon, OH (US); Carol MILLER, Twinsburg, OH (US)

(73) Assignee: AMERICAN GREETINGS CORPORATION, Cleveland, OH (US)

(21) Appl. No.: 13/654,642

(22) Filed: Oct. 18, 2012

Related U.S. Application Data
(63) Continuation-in-part of application No. 12/001,098, filed on Dec. 10, 2007.
(60) Provisional application No. 61/548,426, filed on Oct. 18, 2011.

(51) Int. Cl. G09F 1/04; G06F 19/00

(52) U.S. Cl. 40/124.06

(57) ABSTRACT

The greeting card of the present disclosure and related inventions combines the practicality of a traditional paper greeting card with the advanced capabilities and increased entertainment value of an electronic greeting card. A unique card fold is designed to hold a smart phone, tablet or other web-enabled electronic device. A quick response (QR) code or other digital or optical code or wireless signal, which is linked to a website, application, or other online content, is printed or encoded on the greeting card. After scanning the QR code with an electronic device, a user slides the electronic device into a pocket or cavity contained on or within the greeting card. The destination may contain a slideshow, a video, an interactive game, or other digital content. The greeting card contains various graphics and other printed indicia which correspond directly with the digital content which plays on the electronic device.

### RELATED APPLICATIONS

This application claims priority to U.S. Provisional Patent Application No. 61/548,426, filed on Oct. 18, 2011. This application is also a continuation-in-part of U.S. patent application Ser. No. 12/001,098, filed on Dec. 10, 2007, which claims priority to U.S. Provisional Patent Application No. 60/937,902, filed on Jun. 29, 2007, U.S. Provisional Patent Application No. 60/925,632, filed on Apr. 20, 2007, and U.S. Provisional Patent Application No. 60/873,821, filed on Dec. 8, 2006. Each of the above-referenced patent applications are incorporated herein by reference in its entirety.

### FIELD OF THE INVENTION

The present invention is in the field of social expression products, and more specifically to paper greeting cards that interact with a smart phone via a unique card construct and Quick Response (QR) code.

### BACKGROUND OF THE INVENTION

Electronic greeting cards are known in the art. Greeting cards containing LCD screens built within a greeting card construct allow users to view pre-loaded or user-provided digital content on the greeting card. However, these greeting cards are significantly more expensive than traditional paper greeting cards and usually require several disposable batteries to operate. The cost to mail such electronic cards is also significantly increased. In order to preserve the viewed content, a user must keep and store the electronic greeting card. The content provided on the electronic greeting card is also limited by the amount and type of memory and the power source.

### SUMMARY OF THE INVENTION

The greeting card of the present disclosure and related inventions combines the practicality of a traditional paper greeting card with the advanced capabilities and increased entertainment value of an electronic greeting card. A unique card fold is designed to hold a smart phone, tablet or other web-enabled electronic device. A quick response (QR) code or other digital or optical code or wireless signal, which is linked to a website, application, or other online content, is printed or encoded on the greeting card. In use, after scanning the QR code with an electronic device, a user slides the electronic device into a pocket or cavity contained on or within the greeting card, while the electronic device is connected to a website, application or online content directed to by the QR code. The destination may contain a slideshow, a video, an interactive game, or other digital content. The greeting card contains various graphics and other printed indicia which correspond directly with the digital content which plays on the electronic device. The greeting card creates a frame around or environment within which the digital content of the electronic device interacts.

### DESCRIPTION OF THE DRAWINGS

FIG. 1 is a perspective view of a preferred embodiment of the Smart Phone Greeting Card of the present invention.

FIG. 2 is a perspective view of the Smart Phone Greeting Card of FIG. 1 with smart phone inserted in pocket.

FIG. 3 is a side view of the Smart Phone Greeting Card of FIG. 1.

FIG. 4 is a perspective rear view of the Smart Phone Greeting Card of FIG. 1, with sentiment panel.

FIG. 5 is a front view of an alternate embodiment of the Smart Phone Greeting Card of the present invention.

FIG. 6 is a front view of the Smart Phone Greeting Card of FIG. 5, with smart phone placed thereon.

FIG. 7 is a front view of a slightly alternate embodiment of FIG. 5, with digital tabled placed thereon.

### DETAILED DESCRIPTION OF PREFERRED AND ALTERNATE EMBODIMENTS

The greeting card of the present disclosure and related inventions combines the practicality of a traditional paper greeting card with the advanced capabilities and increased entertainment value of an electronic greeting card. A unique card fold is designed to hold a smart phone, tablet or other web-enabled electronic device (hereinafter referred to collectively as “electronic device”). A quick response (QR) code or other digital or optical code or wireless signal, which is linked to a website, application, or other online content, is printed or encoded on the greeting card. In use, after scanning the QR code with an electronic device, a user slides the electronic device into a pocket or cavity contained on or within the greeting card, while the electronic device is connected to a website, application or online content directed to by the QR code. The destination may contain a slideshow, a video, an interactive game, or other digital content. The greeting card contains various graphics and other printed indicia which correspond directly with the digital content which plays on the electronic device. The greeting card creates a frame around or environment within which the digital content of the electronic device interacts.

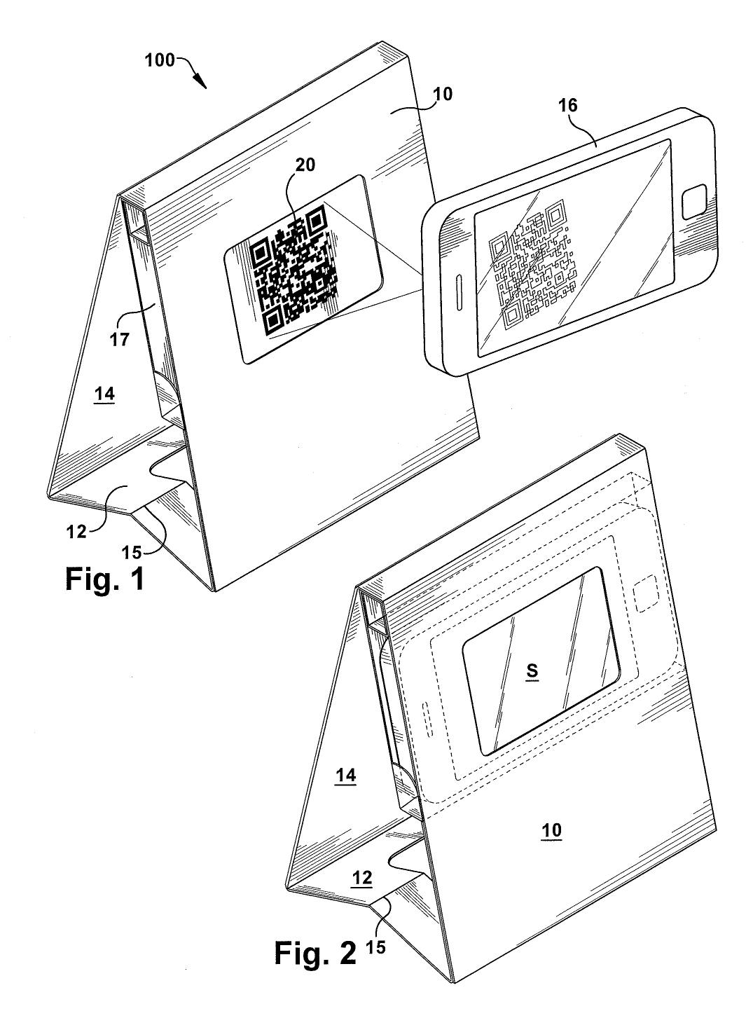

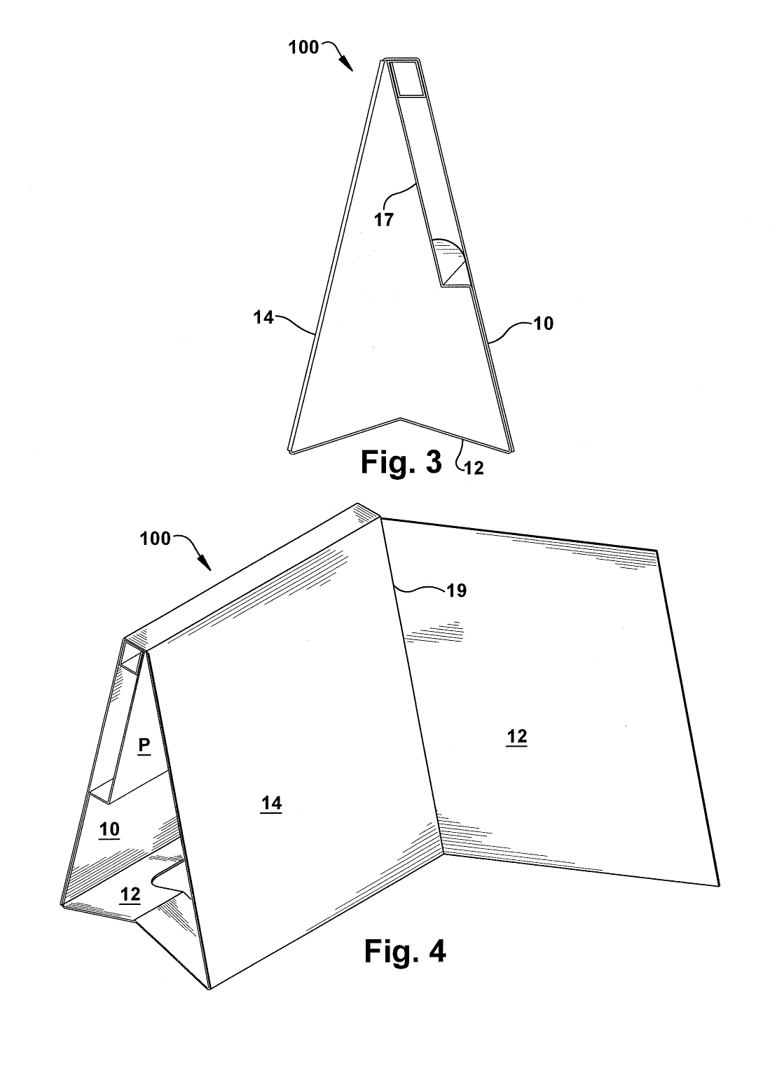

The body of the greeting card may be made of paper, paperboard, plastics, ethylene vinyl acetate (EVA) foam, corrugate or other lightweight substrate capable of holding printed content and being configured to form a pocket thereon for supporting and holding an electronic device. Depending on the electronic device, different materials may be used for different embodiments of the greeting card. For example, a greeting card which is configured to hold a tablet may be made of a sturdier or stronger material than a greeting card which is configured to hold a smart phone. The greeting card body may also incorporate the use of fabric, lights, or other embellishments. The sizes of the greeting card may also be dependent upon the type of electronic device the greeting card is configured to support. In a preferred embodiment, a paperboard greeting card includes several panels which are connected along various fold lines, as shown in FIGS. 1-4. The greeting card 100 is capable of being folded into a first position, which is a substantially flat position, for mailing or insertion into an envelope. The greeting card 100 is also capable of moving from the first substantially flat position to a second upright position. In the second or upright position, the greeting card is configured into a substantially upright triangular position with open sides, as shown in FIG. 3. The triangular position includes a floor panel 12, a front panel 10 and a back panel 14, which are connected along various fold lines or are attached to one another, adhesively or otherwise. The card 100 is stabilized by the floor panel 12 which has a crease or fold line 15 which horizontally bisects the floor panel 12 such that the greeting card 100 rests or is supported along the folds between the front panel 10 and the floor panel 12 and the back panel 14 and the floor panel 12. The front panel 10 of the greeting card 100 contains an opening thereon through which the electronic device 16 or at least the screen S of the electronic device 16 is visible. Behind the front panel 20 is a pocket or enclosure 17 which is attached to the front panel 10 such that an electronic device 16 may be placed into the pocket 17 and retained there between the pocket 17 and the front greeting card panel 10. The two sides of the pocket are open to facilitate easy insertion and removal of the electronic device 16. To insert an electronic device 16 into the pocket 17, the electronic device 16 is slid horizontally into one of the open ends of the pocket 17 until the screen S of the electronic device 16 is visible through the opening in the front greeting card panel 10, as shown in FIG. 2. The opening in the front greeting card panel 10, in a preferred embodiment, is substantially similar in size to the screen S of the electronic device 16. For example, for a greeting card which is designed to accommodate a smart phone, the size of the opening in the front greeting card panel 10 is substantially equal to the size of a standard smart phone screen. For a greeting card which is designed to accommodate a tablet, the size of the opening in the front greeting card panel 10 would be much larger. To remove the electronic device 16, the electronic device 16 is slid horizontally out of one of the open ends of the pocket 17. The greeting card 100 may also contain a flap or panel 18 which is attached to the greeting card 100 along a fold line 19 located along a perimeter edge of the greeting card 100. The flap or panel 18 may cover the front 10 or back 14 panel of the greeting card 100 and serve as a sentiment panel, typical of a standard two panel greeting card. The sentiment panel 18 can be moved away from the greeting card 100 to reveal a greeting, message, or other text sentiment and/or photos, graphics or other printed indicia. If the sentiment panel 18 covers the front panel 10 of the greeting card 100 then moving the panel 18 away from the greeting card 100 would reveal the opening in the front greeting card panel 10 wherein the screen S of an inserted electronic device 16 is visible. Alternatively, as shown in FIG. 4, the sentiment panel 18 may be attached to the back greeting card panel 14.

The panels of the greeting card 100, particularly the front panel 10, contain various graphics which correspond to the digital content played by the electronic device after scanning the QR code. For example, the front greeting card panel 10 may be printed to resemble an old-time television set with knobs or dials representing a channel changer, volume control, and on/off button, and the digital content may contain a segment of or a full episode of a television show. The front panel 10 may be shaped like a traditional greeting card, in a substantially planar square or rectangular configuration having rectilinear edges with the graphics printed thereon. Alternatively, the front panel 10 may take the shape of the graphic printed thereon. For example, if the front greeting panel graphic 10 is a robot, the edges of the front greeting card panel be may be indirect or take the shape of a robot.

A QR code 20 is printed somewhere on the greeting card 100. In a preferred embodiment, the QR code 20 is printed on the front face of the pocket 17 which supports the electronic device 16, such that it can be seen through the opening in the front panel 10 of the greeting card 100, as shown in FIG. 1. A QR code is a type of matrix barcode or two dimensional barcode designed to be read by smart phones and other electronic devices. The code consists of black modules arranged in a square pattern on a white background. The information encoded therein may be made up of any kind of data. In the present invention, the QR code would likely contain an address or a Uniform Resource Locator (URL) which when scanned by a capable electronic device, may display text, connect to a wireless network, or open a web page in the electronic device browser. The content provided may be a video or movie, a slideshow, a television show, or other digital media. The graphics printed on the greeting card 100 are coordinated to the digital content such that it appears as though the paper greeting card creates an environment around the digital content or interacts therewith. As mentioned above, the greeting card 100 may have graphics printed thereon which resemble a television while the digital content is a television show, which creates the illusion that the user is watching a television show on a television. There is no limit on the length of the content that can be played due to the external memory source the electronic device supplies to the greeting card experience. After the electronic content has been viewed by the user, the electronic device may display the option for the user to share the video on Facebook or Twitter. Although a QR code has been disclosed herein as the “trigger device” or link which, once scanned, connects the electronic device to a webpage or other digital content, other triggers or links or connections to digital content can be used and are considered to be within the scope of the present invention. Such triggers or links may include snap tags, Near Field Communication (NFC), URLS or other such navigation tools.

In one embodiment, the greeting card may be associated with a downloadable digital application (commonly referred to as an“app”). The digital application may be retrieved from any application marketplace, such as Apple App Store, Google Play, Chrome Web Store, or any other such marketplace. The application may be downloaded to the consumer's electronic device of choice. Once the consumer has downloaded the application, he/she can scan a QR code (or other such trigger device or link) to be directed to a website wherein he/she can record and/or upload a personalized video message. Once the consumer has recorded his/her personalized message, he/she can present the card to the intended recipient. When the greeting card recipient scans the QR code (or other trigger device or link), he/she will be directed to the personalized message which was recorded specially for him/her.

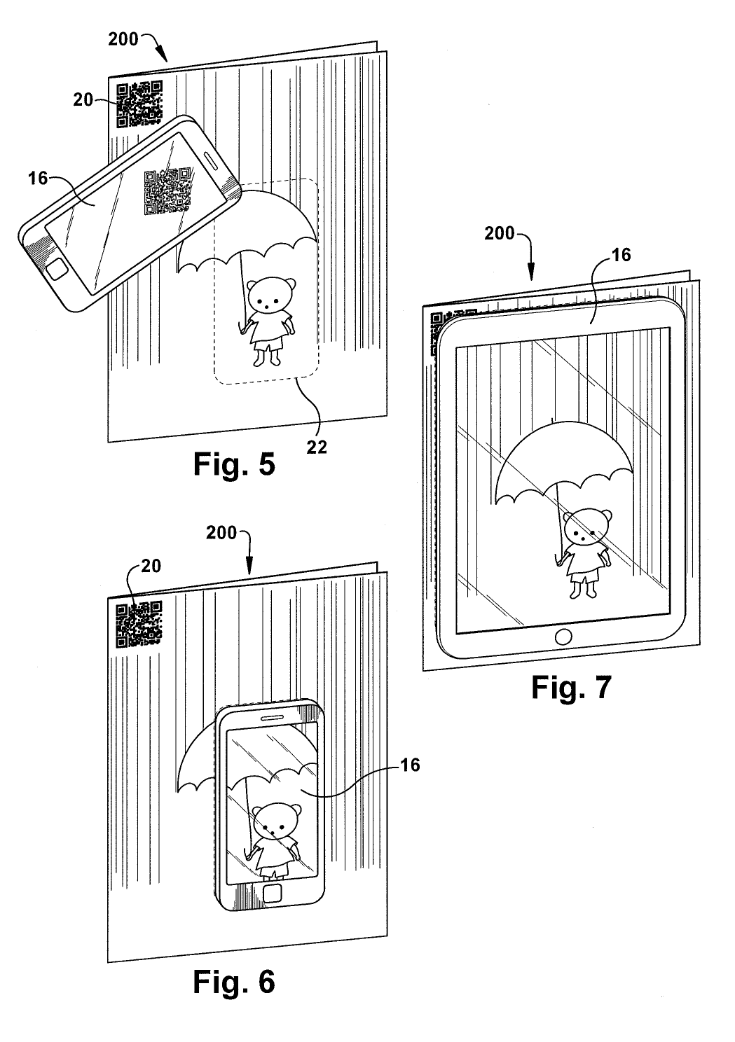

In another embodiment of the present invention, shown in FIGS. 5-7, a traditional two panel paper greeting card 200 may be used in combination with the electronic device 16 and QR code 20. Instead of being placed into a pocket, as described in the preferred embodiment, the electronic device may be placed onto a specified area 22 on the front or inside surface of the greeting card 200. The specified area 22 may be indicated by dashed or solid lines outlining the shape of a smart phone or tablet, as shown in FIG. 5. The graphics printed around that specified area 22 correspond to or are coordinated with the digital content which is launched on the electronic device after scanning the QR code 20. The QR code 20 may be placed near the specified area 22 for the electronic device 16 so the device can quickly be placed in the specified area 22 while the digital content is being launched. The greeting card 200 may be made of paper, paperboard, or other such material and may also incorporate the use of fabric, plastic or other substrates such as EVA foam or corrugate.

In still another embodiment, the greeting card would contain additional components which would provide the user or consumer with the ability to upload personally selected digital audio files to the greeting card for playback upon opening the greeting card. The user uploaded audio files may be uploaded to a memory device within the greeting card via a USB port, an SD card slot, or any other device which facilitates connection to an external memory device. The USB port may be accessed through a side or back of the greeting card and may have a retractable cord. The user-supplied audio file can be played when the greeting card is opened while the record spins.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A greeting card comprising:
a multi-panel greeting card body;
a pocket contained within the multi-panel greeting card body, configured to support an electronic device;
an opening in a front panel of the multi-panel greeting card body, through which a screen on the electronic device is visible;
a code printed on a surface of the multi-panel greeting card body;
wherein when the code is scanned by the electronic device, digital content is displayed on the screen of the electronic device, the content being coordinated with graphics printed on the multi-panel greeting card body.

2. The greeting card of claim 1, wherein the multi-panel greeting card body is capable of being moved from a first, substantially flat position, to a second, upright position.

3. The greeting card of claim 1, wherein the code is a QR code.

4. The greeting card of claim 1, wherein the multi-panel greeting card body creates a frame around the screen of the electronic device.

5. The greeting card of claim 1, wherein the electronic device is a smart phone.

6. The greeting card of claim 1, wherein the multi-panel greeting card body contains open sides.

7. The greeting card of claim 1, wherein the multi-panel greeting card body has a substantially triangular profile.

8. A greeting card comprising:
a greeting card body having at least two attached greeting card panels;
a QR code printed on the greeting card body;
a dashed line area printed on the greeting card;
wherein when the QR code is scanned by an electronic device, and the electronic device is placed within the dashed line area, the electronic device beings to play a video, slideshow, movie or other electronic media content which matches artwork, graphics or other indicia printed on the greeting card in the areas proximate to the dashed line area.

9. The greeting card of claim 8, wherein the electronic media content displayed on the electronic device appears to interact with the surrounding environment printed on the greeting card body.

10. The greeting card of claim 8, wherein the dashed line area is sized to accommodate a smart phone.

11. The greeting card of claim 8, wherein the dashed line area is sized to accommodate an electronic tablet.

12. The greeting card of claim 8, wherein the dashed line area is printed on a front cover of the greeting card.

13. The greeting card of claim 8, wherein the QR code is printed on a front cover of the greeting card.

14. A greeting card comprising:
a greeting card body having one or more greeting card panels;
an open-sided pocket connected to the greeting card body, the open-sided pocket sized to accommodate an electronic device placed therein;
an opening on the greeting card body through which a screen of an electronic device placed into the open-sided pocket is visible;
a QR code printed on the greeting card body or open-sided pocket;
wherein scanning the QR code with an electronic device causes specific digital media content to appear and play on the electronic device, and
wherein placing the electronic device into the open-sided pocket causes the greeting card body to create a frame around the digital media content displayed on the screen of the electronic device.

15. The greeting card of claim 14, wherein the open-sided pocket is sized to accommodate a smart phone.

16. The greeting card of claim 14, wherein the open-sided pocket is sized to accommodate a tablet computer.

17. The greeting card of claim 14, wherein the greeting card body is shaped and configured to resemble a television.

18. The greeting card of claim 17, wherein the screen of the electronic device appears to be a television screen when the electronic device is placed into the open-sided pocket.

19. The greeting card of claim 14, wherein the greeting card may be folded flat.

20. The greeting card of claim 14, wherein the greeting card may be placed in a standing or upright position.
